(19) United States
(12) Patent Application Publication
(10) Pub. No.: US 2021/0102027 A1
(43) Pub. Date: Apr. 8, 2021

(54) Potting Compound and Insulating Material

(71) Applicant: Siemens Aktiengesellschaft, München (DE)

(72) Inventors: Jürgen Huber, Erlangen (DE); Dieter Schirm, Breitengüßbach (DE); Matthias Übler, Ursensollen (DE)

(73) Assignee: Siemens Aktiengesellschaft, München (DE)

(21) Appl. No.: 16/464,587

(22) PCT Filed: Nov. 28, 2017
(86) PCT No.: PCT/EP2017/080610

§ 371 Date: May 28, 2019

(30) Foreign Application Priority Data
Nov. 29, 2016 (DE) 10 2016 223 662.8

(51) Int. Cl. C08G 59/50; C08G 59/68

(52) U.S. Cl. CPC C08G 59/5093; C08G 59/5073; C08G 59/686

(57) ABSTRACT

Various embodiments include a potting compound comprising: a sterically hindered epoxy resin; and a hardener including a basic compound having a pKB, measured in anhydrous acetonitrile, of 23 or higher.

### CROSS-REFERENCE TO RELATED APPLICATIONS

This application is a U.S. National Stage Application of International Application No. PCT/EP2017/080610 filed Nov. 28, 2017, which designates the United States of America, and claims priority to DE Application No. 10 2016 223 662.8 filed Nov. 29, 2016, the contents of which are hereby incorporated by reference in their entirety.

### TECHNICAL FIELD

The present disclosure relates to insulation materials. Various embodiments may include potting compounds, e.g. a compound usable for production of an insulation material by means of anhydride-free curing, and/or the use of potting compounds in an insulation material in switchgear, transformers, cast resin dry-type transformers.

### BACKGROUND

In electrical engineering, especially in switchgear technology, heat-curing, mineral-filled resin formulations are known as potting compounds for manufacture of chemically and electrically highly resistant insulation materials. The base resins used are typically epoxy resin formulations. These are usually processed as two-component (“2K”) batches, wherein a reactive resin or a reactive resin mixture based on bisphenol A or F diglycidyl ether find use in a mixture with phthalic anhydrides (PSAs) and additional additives for improving the flow properties or molding material properties. To enhance the insulating effect under moderate and high electrical voltage stress, for example to improve the partial discharge characteristics or to increase the breakdown resistance, inorganic and organic fillers of microscale and/or nanoscale dimensions are added to the reactive resin mixture, for example silicon oxide derivatives such as quartz flour, alpha-quartz, amorphous fused silica, alumina, mica, boron nitride, wollastonite, aluminum trihydrate in proportions of 50% by weight up to 80% by weight with particle sizes in the micrometer range and/or inorganic and/or organic nanoparticles. To accelerate the thermal gelation/curing, nitrogen derivatives that are cyclic and/or aliphatic in nature are employed.

Since December 2012 it has been known that acid anhydrides, especially hexahydrophthalic anhydride, methylhexahydro-phthalic anhydride and all structural isomers thereof will no longer be permitted in the long term in the EU. The industrial use of these substances therefore has no future, and there is a need to provide a replacement here.

Especially the sterically hindered epoxy resins, especially aliphatic and very particularly cycloaliphatic epoxy resins, based, for example, on epoxidized cyclohexene derivatives such as the diepoxide 3,4-epoxycyclohexylmethyl 3′,4′-epoxycyclohexanecarboxylate, called “ECC” hereinafter, after thermal curing with phthalic anhydride derivatives, in particular with methyltetrahydrophthalic anhydride (“MTHPA”) and the abovementioned methylhexahydrophthalic anhydride (“MHHPA”) which is to be listed as an SVHC, have an excellent spectrum of properties as insulation material, which is the reason for their use as a high-performance outdoor insulating material. By comparison, the glycidyl ether- and glycidyl ester-containing sterically unhindered epoxy resins are readily amenable to anionic curing and, according to the prior art, do not need costly and sensitive superacids for homopolymerization for shaped bodies that are suitable as insulation systems.

As a result of a ban on acid anhydrides that are liquid at room temperature, such as the abovementioned methyltetra-hydrophthalic anhydride (“MTHPA”) and the abovementioned methylhexahydrophthalic anhydride (“MHHPA”) which is to be listed as an SVHC, for example, provision of mobile potting compounds, subsequent curing thereof by the addition mechanism and hence the provision of such insulation materials according to the current prior art is no longer possible without the abovementioned hardeners.

The homopolymerization of sterically hindered epoxy resins, i.e. cycloaliphatic epoxy resins for example, for example of ECC, proceeds very rapidly and completely under thermal and UV-driven conditions via use of what are called cationically active superacids. These species generate very acidic protons in situ, either by thermal breakdown or by UV-driven bond scission with subsequent rearrangement to said superacid derivatives. The catalysts often break down here to give non-nucleophilic anions and very mobile protons which alternately activate the cycloaliphatic epoxy functionalities, for example of ECC, and enable nucleophilic attack by a further epoxy functionality. In this way, cycloaliphatic epoxy resin homopolymerizes to form a very rigid network and high exothermicity. For this purpose, catalysts employed since about 1970 have been, for example, Lewis-acidic SbF₆, PF₅, boron halides or triflate derivatives.

A disadvantage of the superacidic homopolymerization of sterically hindered epoxy resins, i.e. aliphatic and especially also cycloaliphatic epoxy resins for example, is considered to be the overall sensitivity of the catalysts required. Since these derivatives often release the active species for polymerization in situ, either under thermal or UV-driven conditions, these materials are correspondingly highly moisture-, hydrolysis-, heat- and/or light-sensitive. The Lewis-acidic homopolymerization of ECC, for example, even usually on initiation proceeds in an avalanche-like manner, with the result that enormous amounts of heat of up to 600 joules per gram can be released. For that reason, large batches or molding operations that are necessary in industry are often also associated with the risk of fire, since the heat that arises cannot be removed to the outside by virtue of the low conductivity of the molding material formed and hence local breakdowns also result, which significantly worsen the quality of the molding material, especially in electrical engineering use. Owing to the chemical base materials and the complex synthesis regime for provision of the catalyst species of the cationically active superacids such as hexafluorinated antimony and pentafluorinated phosphorus, these catalysts are relatively costly to procure. Homopolymerized, unfilled epoxy resins have therefore only very rarely, if at all, found use in large-volume application, but are instead often only cast in highly mineral-filled form and/or only cured in a very thin layer.

### SUMMARY

The teachings of the present disclosure address some of the disadvantages of the prior art to make homopolymerized, filled or unfilled, sterically hindered epoxy resins available in a large volume and especially to provide an anhydride-free, thermal, alternative method to the superacids for crosslinking to give the high polymer of sterically hindered epoxy resins, for example of the ECC type, with otherwise identical process parameters, for example pressure, temperature, etc. Some embodiments include a hardener for sterically hindered epoxy resins which brings about gradually advancing homopolymerization of the sterically hindered epoxy resin, even in large components, and leads to shaped bodies of low brittleness.

For example, some embodiments include a potting compound comprising a sterically hindered epoxy resin, especially an aliphatic and/or cycloaliphatic epoxy resin, and a hardener comprising at least one basic compound having a pKB, measured in anhydrous acetonitrile, for example an MeCNpKB of 23 or higher.

In some embodiments, the hardener comprises at least one component that exhibits the structural element I

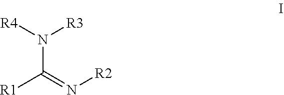

where R1, R2, R3 and/or R4 are the same or different and are, for example, hydrogen, branched or unbranched alkyl, acyl and/or aryl moieties and/or form at least one cycle especially via bridge formation between R2/R3 and/or R1/R4, where, in an advantageous embodiment, R4=H.

In some embodiments, the hardener does not have any NH functionality in the molecular structure.

In some embodiments, the component having the structural element I is present in the hardener as a ligand in a complex.

In some embodiments, the hardener comprises the compound DBN, 1,5-diazabicyclo[4.3.0]non-5-ene, CAS No. 3001-72-7, having the structural formula II

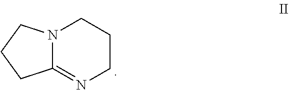

In some embodiments, the component having the structural element I is present in the hardener as an adduct with an acrylate, an acrylate derivative and/or a compound containing oxirane groups and having a defined molecular length, especially with up to 50 carbon atoms.

In some embodiments, the component having the structural element I is a derivative of the group of the following parent compounds:

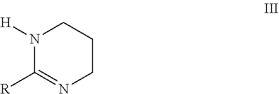

1,4,5,6-tetrahydro-2R-pyrimidine, which is present in the hardener as parent compound or base structure and in pure form and/or as derivative, and/or

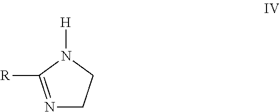

1H-2R-2-imidazoline, which is present as parent compound or base structure which is present in pure form and/or as derivative in the hardener; where R=methyl, ethyl, propyl, isopropyl, butyl, isobutyl, benzyl, phenyl, fluorine, chlorine, bromine, iodine, hydroxyl, aldehyde, carboxylate.

In some embodiments, the component having the structural element I present in the hardener is at least one compound selected from the group of the following compounds:
ectoine (CAS No. 96702-03-3) and/or any ectoine derivative,
1,4,5,6-tetrahydropyrimidine (CAS No. 1606-49-1),
1,4,5,6-tetrahydro-2-methylpyrimidine,
1,4,5,6-tetrahydro-2-ethylpyrimidine,
1,4,5,6-tetrahydro-2-propylpyrimidine,
1,4,5,6-tetrahydro-2-isopropylpyrimidine,
1,4,5,6-tetrahydro-2-butylpyrimidine,
1,4,5,6-tetrahydro-2-isobutylpyrimidine,
1,4,5,6-tetrahydro-2-phenylpyrimidine,
1,4,5,6-tetrahydro-2-benzylpyrimidine,
1,4,5,6-tetrahydro-2-fluoropyrimidine,
1,4,5,6-tetrahydro-2-chloropyrimidine,
1,4,5,6-tetrahydro-2-bromopyrimidine,
1,4,5,6-tetrahydro-2-iodopyrimidine,
1,4,5,6-tetrahydro-2-cyanopyrimidine,
2-methyl-2-imidazoline (CAS No. 534-26-9),
2-phenyl-2-imidazoline (CAS No. 936-49-2),
2-benzyl-2-imidazoline (CAS No. 59-98-3),
2,4-dimethyl-2-imidazoline (CAS No. 930-61-0),
4,4-dimethyl-2-imidazoline (CAS No. 2305-59-1), and any mixtures of the aforementioned compounds.

In some embodiments, at least one component having n=1 to 4 covalently bonded hydroxyl groups is present in the hardener.

In some embodiments, at least one compound having one of the structural formulae V to X is present in the hardener alone or in a mixture with further compounds:

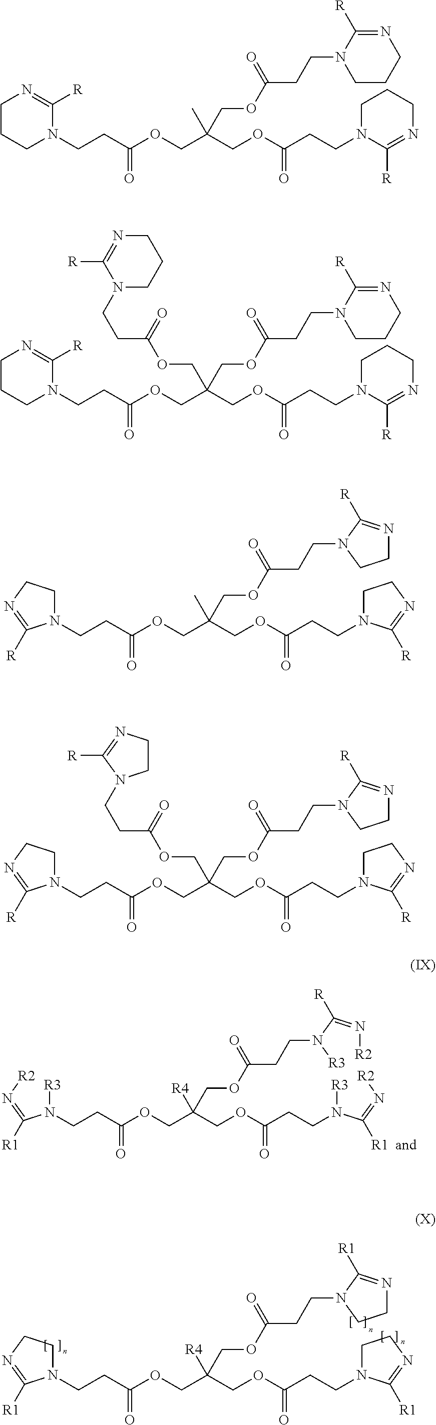

where
R1, R2, R3 and R4=H, methyl, ethyl, propyl, isopropyl, butyl, isobutyl, benzyl, phenyl and n=1 to 12.

In some embodiments, the component having the structural element I takes the form of an adduct with an acrylate and/or an acrylate derivative, for example TMPTA (trimethylolpropane triacrylate), trimethylolpropane propoxylate triacrylate, dipentaerythritol penta-acrylate/dipentaerythritol hexaacrylate and/or PETA (pentaerythritol tetraacrylate), and any mixtures of the acrylates and/or acrylate derivatives.

In some embodiments, the component having the structural element I takes the form of an adduct with a compound containing oxirane groups and having a defined molecular length, for example a glycidyl compound, especially one having fewer than 50 carbon atoms.

In some embodiments, the component having the structural element I takes the form of an adduct with a glycidyl compound, selected from the following compounds, and any mixtures thereof: monoglycidyl ether and/or ester compound, diglycidyl ether and/or ester compound, triglycidyl ether and/or ester compound and/or tetraglycidyl ether and/or ester compound.

In some embodiments, the component having the structural element I takes the form of an adduct with a compound containing oxirane groups and of defined molecular length having n=1 to n=4 oxirane functionalities.

In some embodiments, the compound containing oxirane groups is a derivative of a higher alcohol, a bisphenol, diol, triol, for example from the group of the following compounds:
monoethylene glycol (C₂H₄)(OH)₂,
butanediols (C₄H₈)(OH)₂,
butenediols (C₄H₆)(OH)₂,
butynediol (C₄H₄)(OH)₂,
polyethylene glycols H(OC₂H₄)x(OH)₂ with x=1 to 5000,
propylene glycol (C₃H₆)(OH)₂,
polypropylene glycols H(OC₃H₆)x(OH)₂ with x=1 to 5000,
diethylene glycol (C₂H₈O)(OH)₂,
propanediols (C₃H₆)(OH)₂,
neopentyl glycol (C₅H₁₀)(OH)₂,
cyclopentanediols (C₅H₈)(OH)₂,
cyclopentenediols (C₅H₆)(OH)₂,
glycerol (C₃H₅)(OH)₃,
pentanediols (C₅H₁₀)(OH)₂,
pentaerythritol (C₅H₈)(OH)₄,
hexanediols (C₆H₁₂)(OH)₂,
hexylene glycols (C₆H₁₂)(OH)₂,
heptanediols (C₇H₁₄)(OH)₂,
octanediols (C₈H₁₆)(OH)₂,
polycaprolactonediols, polycaprolactonetriols, hydroquinone (C₆H₄)(OH)₂,
resorcinol (C₆H₄)(OH) ₂,
(pyro)catechol (C₆H₄)(OH)₂,
rucinol (C₁₀H₁₂)(OH)₂,
triethylene glycol (C₆H₁₂)(OH)₂
   fully aromatic, partly hydrogenated and/or fully hydrogenated bisphenol A (C₁₅H₁₄)(OH)₂, (C₁₅H₂₈)(OH)₂, bisphenol F (C₁₃H₁₀)(OH)₂, bisphenol S (C₁₂H₈O₂S)(OH)₂
   tricyclodecanedimethanol (C₁₂H₁₈)(OH)₂, glycerol carbonate (C₄H₅)(OH)₁.

In some embodiments, the hardener has a nitrogen density D in the range from 1 mmol/g to 15 mmol/g.

In some embodiments, compounds of the following structure types XI to XIV are present in the hardener on their own or in the form of any desired mixtures:

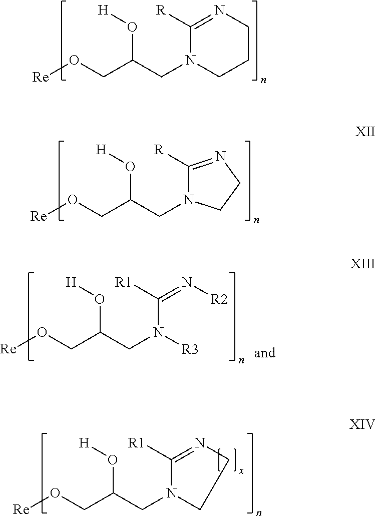

where
R1, R2 and R3=methyl, ethyl, propyl, isopropyl, butyl, isobutyl, benzyl, phenyl,
x=1 to 12 and n=1 to 4.

In some embodiments, the hardener is present in the potting compound in an amount of up to 25% by weight, based on the total mass of the potting compound.

In some embodiments, there are additives, flame retardants and/or reactive diluents.

In some embodiments, the hardener is in filled or unfilled form.

In some embodiments, the filler takes the form of a filler combination.

As another example, some embodiments include an insulation material obtainable by casting and curing the potting compound as described above.

As another example, some embodiments include an insulation system, especially relating to electrical insulation, comprising an insulation material as described above.

As another example, some embodiments include the use of the potting compound, in filler-containing or filler-free form, by anionic gelation and/or curing as casting resin, infusion resin, impregnation resin and/or encapsulating resin in electrical engineering.

### BRIEF DESCRIPTION OF THE DRAWINGS

FIG. 1 shows, according to Gelnorm®, temperature-dependent gelation times for various compounds incorporating teachings of the present disclosure.

FIG. 2 shows the glass transitions in DBN (5% by weight) in ECC molding material after 10 h at 145° C.

FIG. 3 shows differential calorimetry analysis of anionically initiated homopolymerization of ECC with DBN as catalyst.

FIG. 4 shows the Tg characteristic of the ECC cured with 5% DBN.

### DETAILED DESCRIPTION

The teachings of the present disclosure describe a potting compound comprising a sterically hindered epoxy resin, e.g. an aliphatic and/or cycloaliphatic epoxy resin, and a hardener comprising a basic compound that exhibits the structural element I

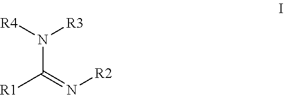

where R1, R2, R3 and/or R4 are the same or different and are, for example, hydrogen, branched or unbranched alkyl, acyl and/or aryl moieties and/or form at least one cycle especially via bridge formation between R2/R3 and/or R1/R4, where, in an advantageous embodiment, R4=H. Some embodiments include an insulation material obtainable by casting and curing this potting compound, and an insulation system comprising such an insulation material for electrical insulation. Finally, the teachings describe the use of the potting compound, in filler-containing or filler-free form, by anionic gelation and/or curing as casting resin, infusion resin, impregnation resin and/or encapsulating resin in electrical engineering.

Insulation materials incorporating teachings of the present disclosure are used, for example, for insulation and/or encapsulation in electrical engineering. In particular, they serve as winding insulation in electrical machines such as transformers, cast resin dry-type transformers etc. as main insulation. The potting compounds are used here, for example, via vacuum pressure impregnation after curing for encapsulation of insulating winding tapes. Contrary to the prior art—the anionic homopolymerization—i.e. the polymerization of identical monomer units—especially of cycloaliphatic, sterically hindered, glycidyl ester- and glycidyl ether-free epoxy resin is possible without use of hardeners based on acid anhydrides.

The class of epoxy resins described here, as well as the sterically hindered cycloaliphatic epoxy resin ECC (3,4-epoxycyclohexylmethyl 3′,4′-epoxycyclohexanecarboxylate), also generally includes aliphatic hindered epoxy resins, for example epoxidized soybean oils. Exclusively the glycidyl ether- and glycidyl ester-free sterically hindered epoxy resins, in aliphatic or cycloaliphatic form, are discussed here as a basis for potting compounds in the present disclosure. According to widespread scientific opinion (cf. thesis by A. M. Tomuta, New and improved thermosets based on epoxy resins and dendritic polyesters (2014), Universitat Rovira i Virgili, Departament de Química Analítica i Química Orgànica, Tarragona, Spain; see page 5 and page 9) and the generally accepted prior art, it is not possible to anionically homopolymerize cycloaliphatic or aliphatic epoxy resins. This thesis from 2014 explicitly says that “cycloaliphatic epoxy resins cannot be cured by anionic initiators”. Anionic initiators, as the person skilled in the art knows, bring about a basic and not an acidic curing reaction.

The acidic, especially Lewis-acidic, ring opening by means of superacidic protons known to date, as set out above, owing to the higher ring stress in the cycloaliphatic epoxy resin, for instance ECC, leads to quantitative opening and hence to virtually complete homopolymerization. Anionic activation with standard nucleophilic tertiary, secondary and primary amine hardeners, for example with 1-alkylimidazoles, dimethylbenzylamine, Jeffamines, diethylenetriamine, triethylenetetramine, isophoronediamine, aminoethylpiperazine, diaminocyclohexane, diaminodiphenylmethane, phenylenediamine or diaminophenyl sulfone, leads to only extremely slow gelation, if any, even at high temperatures of 70-90° C., or to only soft hardening, if any, to give the shaped body.

However, it has been found, surprisingly, and in an unforeseeable manner to the person skilled in the art, that certain nonacidic superbases are indeed capable of gelating a sterically hindered epoxy resin at temperatures of 70-100° C. that are customary in the art, especially an aliphatic epoxy resin, for example a cycloaliphatic epoxy resin such as the advantageous diepoxide ECC, with moderate accelerator contents, and of homopolymerizing it in the course of curing at 145° C. over 10 h to give the faultless shaped body. In some embodiments, strong superbases having pKB values complementary to those of the superacid used to date are suitable for functioning as hardener for the sterically hindered epoxy resins.

In some embodiments, the formulation includes superbases which, for the conjugated acid, measured in anhydrous acetonitrile, show a MeCNpKBH+ value of 23.5 or higher. In some embodiments, the hardener is a superbase having at least one structural element I

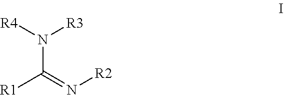

where R1, R2, R3 and/or R4 are the same or different and are, for example, hydrogen, branched or unbranched alkyl, acyl and aryl moieties and form a cycle via bridge formation between R2/R3 and/or R1/R4, where, in some embodiments, R4=H.

In some embodiments, the hardener does not have any NH functionalities in the molecular structure. To improve the ease of handling and processibility of the hardener, especially also to improve the stability under air and/or the vacuum stability of the hardener, it can be used in the form of an adduct and/or a complex, especially complexed to a metal salt. The term “complex” or “complexed” is used here in the organometallic sense of the word, i.e. in such a way that the hardener is attached to a central atom as ligand, but by no means provides all ligands of the complex around the central atom. It is accordingly also possible for other ligands that do not assume any hardener function in the sterically hindered epoxy resin to be provided in the complex used.

In some embodiments, the basic hardener with the structural element I shown above is used in the form of a copper and/or zinc salt, for instance as Zn(SCN)₂*(DBN)₂ or Zn(Cl)₂*(DBN)₂.

In some embodiments, the hardener comprises 1,5-diazabicyclo[4.3.0]non-5-ene, CAS No. 3001-72-7, referred to hereinafter as “DBN” for short, having the structural formula II

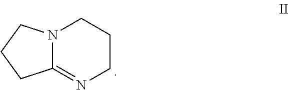

In some embodiments, the basic hardener having the structural element I shown above is used in the form of a copper and/or zinc salt, for instance as Zn(SCN)₂*(DBN)₂ or Zn(Cl)₂*(DBN)₂. Since DBN is a very mobile compound at room temperature that has only relatively low vacuum stability at higher temperatures, in addition to sole use as hardener, it may be useful to couple the molecule or the active environment responsible for the homopolymerization of ECC covalently to other molecules of higher molecular weight, such as compounds containing acrylate, acrylate derivative and/or oxirane groups, in order thus to increase vacuum stability.

The following structures show illustrative parent compounds for hardener components:

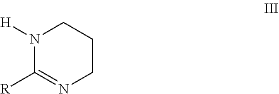

1,4,5,6-tetrahydro-2R-pyrimidines parent compound or base structure which is present in pure form and/or as derivative in the hardener, and/or

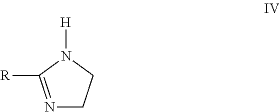

1H-2R-2-imidazoline as parent compound or base structure which is present in pure form and/or as derivative in the hardener; where R=methyl, ethyl, propyl, isopropyl, butyl, isobutyl, benzyl, phenyl, fluorine, chlorine, bromine, iodine, hydroxyl, aldehyde, carboxylate.

The abovementioned structures III and IV can be reacted efficiently with acrylates such as TMPTA (trimethylolpropane triacrylate), trimethylolpropane propoxylate triacrylate, pentaerythritol tetraacrylate (PETA), dipentaerythritol penta-acrylate/dipentaerythritol hexaacrylate and/or compounds containing oxirane groups and of defined molecular length for stabilization.

For example, an adduct of one of the following compounds with an acrylate or an acrylate derivative and/or a compound containing oxirane groups and having a defined molecular length is used as hardener:

ectoine (CAS No. 96702-03-3) and/or any ectoine derivative,

1,4,5,6-tetrahydropyrimidine (CAS No. 1606-49-1),

1,4,5,6-tetrahydro-2-methylpyrimidine,

1,4,5,6-tetrahydro-2-ethylpyrimidine,

1,4,5,6-tetrahydro-2-propylpyrimidine,

1,4,5,6-tetrahydro-2-isopropylpyrimidine,

1,4,5,6-tetrahydro-2-butylpyrimidine,

1,4,5,6-tetrahydro-2-isobutylpyrimidine,

1,4,5,6-tetrahydro-2-phenylpyrimidine,

1,4,5,6-tetrahydro-2-benzylpyrimidine,

1,4,5,6-tetrahydro-2-fluoropyrimidine,

1,4,5,6-tetrahydro-2-chloropyrimidine,

1,4,5,6-tetrahydro-2-bromopyrimidine,

1,4,5,6-tetrahydro-2-iodopyrimidine,

1,4,5,6-tetrahydro-2-cyanopyrimidine,

2-methyl-2-imidazoline (CAS No. 534-26-9),

2-phenyl-2-imidazoline (CAS No. 936-49-2),

2-benzyl-2-imidazoline (CAS No. 59-98-3),

2,4-dimethyl-2-imidazoline (CAS No. 930-61-0),

4,4-dimethyl-2-imidazoline (CAS No. 2305-59-1), and any mixtures of the aforementioned compounds.

In addition, in some embodiments, the hardener comprises, for example, a component with n=1 to 4 covalently bonded hydroxyl groups per molecule. For example, addition products present in the hardener on their own or in the form of any desired mixtures in advantageous working examples of the present invention may be the following compounds having the structural formulae V to X:

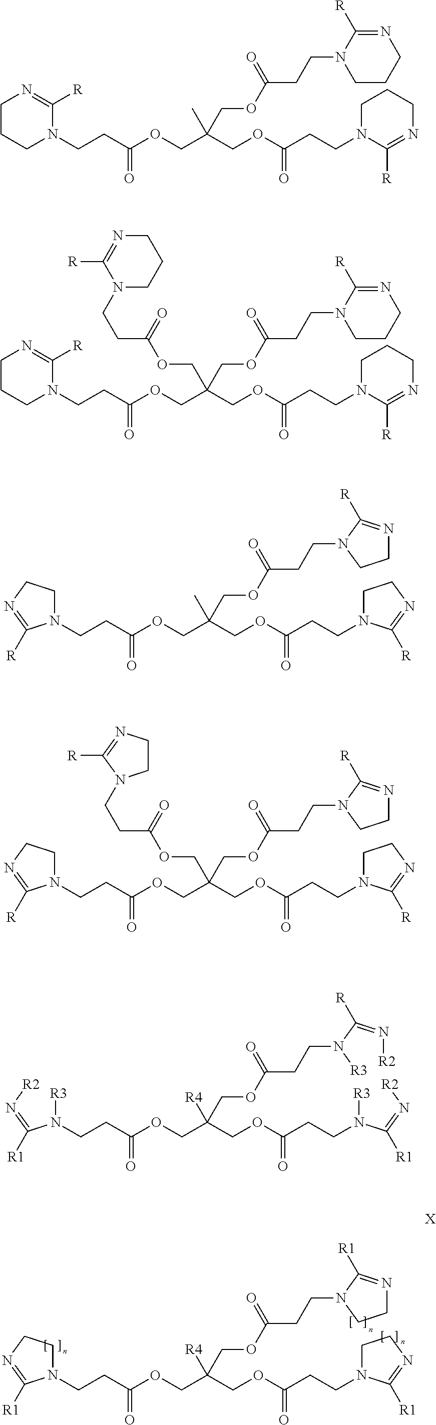

where

R1, R2, R3 and R4=H, methyl, ethyl, propyl, isopropyl, butyl, isobutyl, benzyl, phenyl

and n=1 to 12.

In some embodiments, in the hardener, the binding of the superbase to the structural unit I, for stabilization thereof, may also be to a compound containing oxirane groups and of defined molecular length, for example to a glycidyl compound, for example a glycidyl ether or glycidyl ester compound, especially one having fewer than 50 carbon atoms. For example, the binding is to a compound containing oxirane groups and of defined molecular length that has n=1 to 4 oxirane functionalities per molecule.

For example, it is possible here to use the following oxirane-containing compounds, especially glycidyl compounds, the adducts of which with the component containing the structural unit I are present in the hardener:

monoglycidyl ether and/or ester compound (n=1),

diglycidyl ether and/or ester compound (n=2),

triglycidyl ether and/or ester compound (n=3) and/or

tetraglycidyl ether and/or ester compound (n=4), and any mixtures of the compounds mentioned.

In some embodiments, the glycidyl compound may be derived from a bisphenol, diol, triol and/or higher alcohol, for example from the group of the following compounds:

monoethylene glycol (C₂H₄)(OH)₂,

butanediols (C₄H₈)(OH)₂,

butenediols (C₄H₆)(OH)₂,

butynediol (C₄H₄)(OH)₂,

polyethylene glycols H(OC₂H₄)x(OH)₂ with x=1 to 5000,

propylene glycol (C₃H₆)(OH)₂,

polypropylene glycols H(OC₃H₆)x(OH)₂ with x=1 to 5000,

diethylene glycol (C₂H₈O)(OH)₂,

propanediols (C₃H₆)(OH)₂,

neopentyl glycol (C₅H₁₀)(OH)₂,

cyclopentanediols (C₅H₈)(OH)₂,

cyclopentenediols (C₅H₆)(OH)₂,

glycerol (C₃H₅)(OH)₃,

pentanediols (C₅H₁₀)(OH)₂,

pentaerythritol (C₅H₈)(OH)₄,

hexanediols (C₆H₁₂)(OH)₂,

hexylene glycols (C₆H₁₂)(OH)₂,

heptanediols (C₇H₁₄)(OH)₂,

octanediols (C₈H₁₆)(OH)₂,

polycaprolactonediols, polycaprolactonetriols, hydroquinone (C₆H₄)(OH)₂,

resorcinol (C₆H₄)(OH)₂,

(pyro)catechol (C₆H₄)(OH)₂,

rucinol (C₁₀H₁₂)(OH)₂,

triethylene glycol (C₆H₁₂)(OH)₂
fully aromatic, partly hydrogenated and/or fully hydrogenated bisphenol A (C₁₅H₁₄)(OH)₂, (C₁₅H₂₈)(OH)₂, bisphenol F (C₁₃H₁₀)(OH)₂, bisphenol S (C₁₂H₈O₂S)(OH)₂
tricyclodecanedimethanol (C₁₂H₁₈)(OH)₂, glycerol carbonate (C₄H₅)(OH)₁.

In some embodiments, the hardener has a nitrogen density D in the range from 1 to 15 mmol/g. The mass-specific, polymerization-capable molar nitrogen density D used here is defined by the unit 10⁻³ mol/g (corresponding to one thousandth of a mole per gram), which indicates the content of nitrogen atoms having nonaromatic and simultaneously non-binding electron pairs per molecule and function as anionic polymerization initiators.

In some embodiments, in the hardener, compounds of the following structure types XI to XIV may be present on their own or as any desired mixtures:

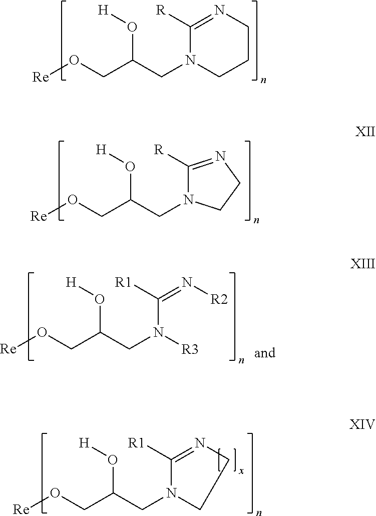

where R1, R2 and R3=methyl, ethyl, propyl, isopropyl, butyl, isobutyl, benzyl, phenyl, and x=1 to 12, and n=1 to 4.

A derivative in the present context is understood to mean any component obtainable by reaction of the parent compound, i.e. compounds whose molecules contain another atom or another atom group rather than a hydrogen atom or a functional group or in which an atom or atom group has been removed. The chemical and physical properties of derivatives are often no longer even similar at all to those of the parent compounds but may be similar. The preparation of a chemical derivative is called derivatization.

In some embodiments, the curing catalyst is present in the solid insulation material in an amount of less than 25% by weight, for example from 0.001% by weight to 15% by weight, or in the range from 0.01% by weight to 10% by weight, or even from 0.1% by weight to 5% by weight, and so gelation times of several hours are achievable.

In some embodiments, the potting compound formed from an aliphatic and/or cycloaliphatic epoxy resin reacts with a hardener comprising a compound having the structure I within a gelation time of 0.5 h to 48 h, or of 0.5 h to 24 h, and/or of 0.5 h to 16 h under reduced pressure and at encapsulation temperature.

The potting compound and the insulation material producible therefrom may contain one or more epoxidized reactive diluents, i.e. aromatic and/or aliphatic, short- to long-chain and/or cyclic glycidyl ethers; cyclic reactive diluents such as ethylene carbonate, propylene carbonate, butylene carbonate, glycerol carbonate, glycolic and/or epoxidized polypropylene glycols. The potting compound may contain fillers and/or filler combinations. For example, it is possible to employ microscale fillers composed of quartz flour, boron nitride, fused silica, alumina, wollastonite or aluminum oxide trihydrate. For example, it is possible to employ semiconductive microscale and/or nanoscale fillers or filler combinations or doped fillers or filler combinations.

The potting compound may include conventional flame retardants and/or flame retardant combinations, and any other additives. In some embodiments, the homopolymerization is effected anionically.

In some embodiments, the curing catalyst initiates the polymerization of the potting resin at encapsulation temperatures in the range from 20° C. to 150° C., or from 40° C. to 90° C., and/or from 55° C. to 80° C.

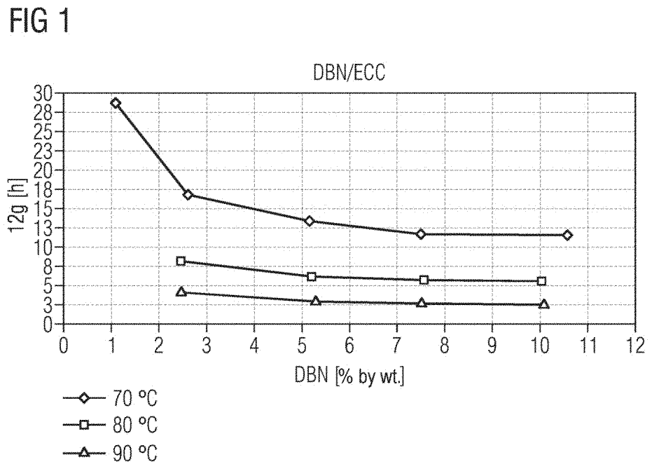

Some embodiments include the curing of a potting compound of cycloaliphatic ECC, i.e. diepoxide 3,4-epoxycyclohexylmethyl 3′,4′-epoxycyclohexanecarboxylate, with 5% by weight of DBN, i.e. 1,5-diazabicyclo[4.3.0]non-5-ene. As a test, the curing was first conducted at 145° C. for 10 h. It was possible to produce a clear, solid and faultless shaped body. According to Gelnorm®, the gelation times were determined as shown in FIG. 1. For this purpose, temperature-dependent gel times were determined at 70° C. to 90° C. with 1% to 10% by weight of DBN in ECC.

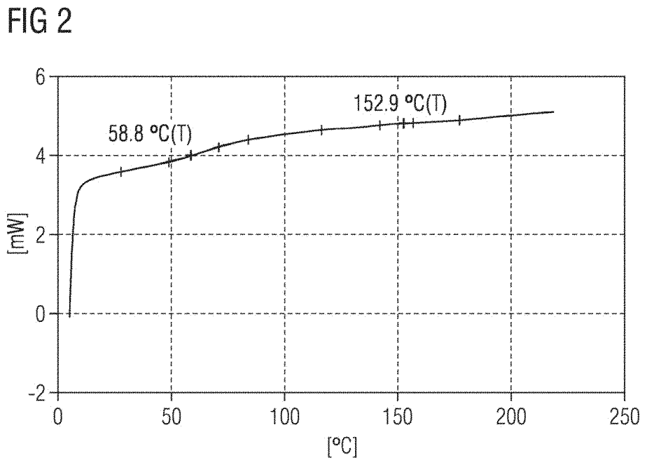

The molding material cured in this way with about 5% by weight of DBM in ECC was examined by means of dynamic differential calorimetry (10 K/min, in nitrogen atmosphere, TA DSC Q100), and two glass transition ranges can be detected. For instance, a well pronounced first glass transition is found at about 60° C., and a less pronounced glass transition at about 153° C., as shown in FIG. 2. It can therefore be assumed that two homo-polymerization stages exist in the network, which cause the toughness of the molding material. An adapted hardness profile, for example longer times and/or higher temperatures, move the glass transition ratio in favor of the higher glass transition.

FIG. 2 shows the glass transitions in DBN (5% by weight) in ECC molding material after 10 h at 145° C.

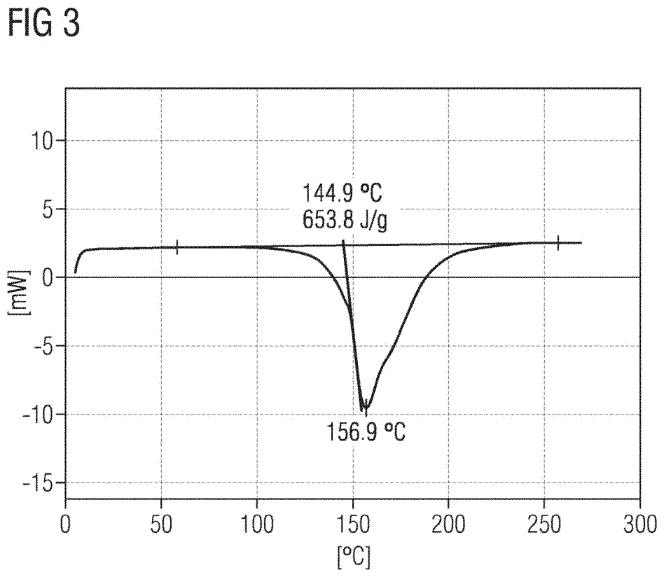

To detect the homopolymerization of ECC by means of DBN, a differential calorimetry analysis of the anionically initiated homopolymerization of the potting compound composed of ECC with DBN as hardener was conducted, with DBN present in the ECC at 7.5% by weight. DBN was stirred into ECC and heated up in flanged crucibles at a heating rate of 10 K/min in a DSC under a nitrogen atmosphere. The graph is shown in FIG. 3. With a reaction enthalpy of more than 650 J/g and an exothermic peak of about 157° C., the homopolymerization of ECC proceeds similarly in terms of mechanism to cationic homopolymerization initiated by superacids.

The differential calorimetry analysis of the anionically initiated homopolymerization of ECC with DBN as catalyst which is shown in FIG. 3 demonstrates the anionic curing.

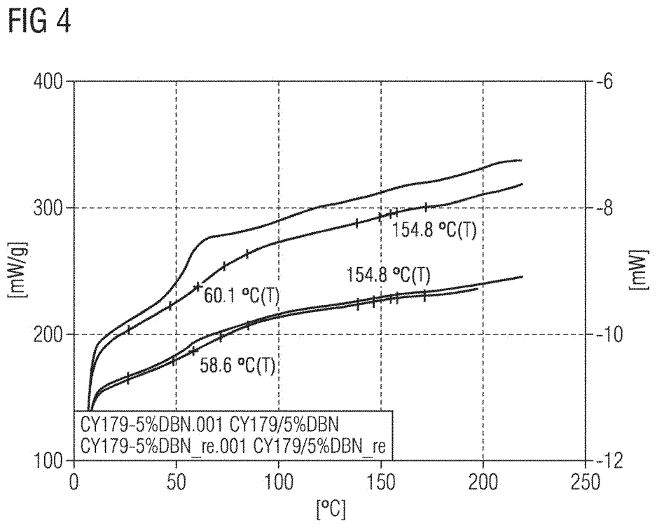

The mixture of 5% DBN in ECC (here in the form of CY179 from Huntsman) thus gives rise to a brittle molding material. FIG. 4 shows the Tg characteristic of the ECC cured with 5% DBN. This is entirely new in the technical field and surprising because anionic polymerization by DBN of sterically hindered ECC was hitherto considered to be impossible.

Since the focus is on anhydride-free polymerization, all that remains in reality is what is called “homopolymerization”, for example of ECC, i.e. the intercrosslinking of the ECC monomer to give a polymeric material. At the same time, the catalyst disclosed here for the first time is less costly, readily available and less sensitive to moisture and light than the superacids customary to date. The resulting molding material is simultaneously significantly less hydrolysis-sensitive owing to its network structure.

Some embodiments include a potting compound with a hardener component by means of which anionically initiated homopolymerization of sterically hindered epoxy resins, which was considered to be unfeasible according to prior art to date, is enabled. For this purpose, what are called superbases having a pKB greater than 23 are used.

What is claimed is:

1. A potting compound comprising:
a sterically hindered epoxy resin; and
a hardener including a basic compound having a pKB, measured in anhydrous acetonitrile, of 23 or higher.

2. The potting compound as claimed in claim 1, wherein the hardener comprises a component including the structural element I 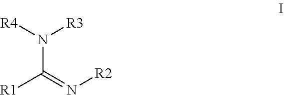
wherein R1, R2, R3 and/or R4 each include at least one component selected from the group consisting of: hydrogen, branched or unbranched alkyl, acyl, and/or aryl moieties; and/or
form a cycle between R2/R3 and/or R1/R4.

3. The potting compound as claimed in claim 1, wherein the hardener does not include any NH functionality in the molecular structure.

4. The potting compound as claimed in claim 1, wherein the component having the structural element I comprises a ligand in a complex.

5. The potting compound as claimed in claim 1, wherein the hardener comprises a compound DBN, 1,5-diazabicyclo[4.3.0]non-5-ene, CAS No. 3001-72-7, having the structural formula II

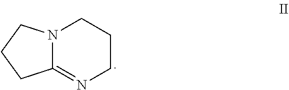

6. The potting compound as claimed in claim 1, wherein the component having the structural element I comprises an adduct with an acrylate, an acrylate derivative, and/or a compound containing oxirane groups.

7. The potting compound as claimed in claim 1, wherein the component having the structural element I comprises:
a derivative of the group of the following parent compounds: 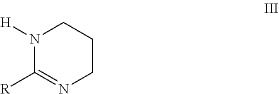
1,4,5,6-tetrahydro-2R-pyrimidine; and/or 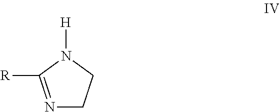
1H-2R-2-imidazoline;
where R=methyl, ethyl, propyl, isopropyl, butyl, isobutyl, benzyl, phenyl, fluorine, chlorine, bromine, iodine, hydroxyl, aldehyde, and/or carboxylate.

8. The potting compound as claimed in claim 1, wherein the component having the structural element I comprises a compound selected from the group consisting of:
ectoine (CAS No. 96702-03-3) and/or any ectoine derivative,
1,4,5,6-tetrahydropyrimidine (CAS No. 1606-49-1),
1,4,5,6-tetrahydro-2-methylpyrimidine,
1,4,5,6-tetrahydro-2-ethylpyrimidine,
1,4,5,6-tetrahydro-2-propylpyrimidine,
1,4,5,6-tetrahydro-2-isopropylpyrimidine,
1,4,5,6-tetrahydro-2-butylpyrimidine,
1,4,5,6-tetrahydro-2-isobutylpyrimidine,
1,4,5,6-tetrahydro-2-phenylpyrimidine,
1,4,5,6-tetrahydro-2-benzylpyrimidine,
1,4,5,6-tetrahydro-2-fluoropyrimidine,
1,4,5,6-tetrahydro-2-chloropyrimidine,
1,4,5,6-tetrahydro-2-bromopyrimidine,
1,4,5,6-tetrahydro-2-iodopyrimidine,
1,4,5,6-tetrahydro-2-cyanopyrimidine,
2-methyl-2-imidazoline (CAS No. 534-26-9),
2-phenyl-2-imidazoline (CAS No. 936-49-2),
2-benzyl-2-imidazoline (CAS No. 59-98-3),
2,4-dimethyl-2-imidazoline (CAS No. 930-61-0), and
4,4-dimethyl-2-imidazoline (CAS No. 2305-59-1).

9. The potting compound as claimed in claim 1, wherein the hardener comprises a component having n=1 to 4 covalently bonded hydroxyl groups.

10. The potting compound as claimed in claim 1, wherein the hardener comprises a compound having one of the structural formulae V to X: 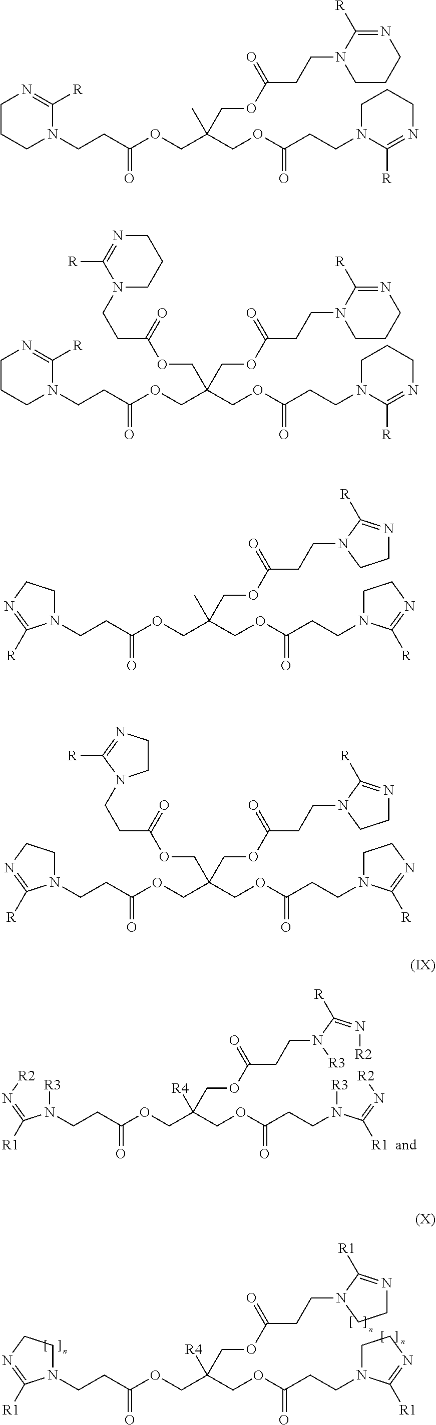
wherein
R1, R2, R3, and R4 each comprise a component selected from the group consisting of H, methyl, ethyl, propyl, isopropyl, butyl, isobutyl, benzyl, and phenyl; and
n=1 to 12.

11. The potting compound as claimed in claim 1, wherein the component having the structural element I comprises an adduct with an acrylate and/or an acrylate derivative.

12. The potting compound as claimed in claim 1, wherein the component having the structural element I comprises an adduct with a compound containing oxirane groups and having a defined molecular length.

13. The potting compound as claimed in claim 12, wherein the component having the structural element I comprises an adduct with a glycidyl compound selected from the group consisting of: monoglycidyl ether and/or ester compound, diglycidyl ether and/or ester compound, triglycidyl ether and/or ester compound, and tetraglycidyl ether and/or ester compound.

14. The potting compound as claimed in claim 1, wherein the component having the structural element I comprises an adduct with a compound containing oxirane groups and of defined molecular length having n=1 to n=4 oxirane functionalities.

15. The potting compound as claimed in claim 1, wherein the compound containing oxirane groups comprises a derivative of a higher alcohol selected from the group consisting of:
monoethylene glycol (C₂H₄)(OH)₂,
butanediols (C₄H₈)(OH)₂,
butenediols (C₄H₆)(OH)₂,
butynediol (C₄H₄)(OH)₂,
polyethylene glycols H(OC₂H₄)x(OH)₂ with x=1 to 5000,
propylene glycol (C₃H₆)(OH)₂,
polypropylene glycols H(OC₃H₆)x(OH)₂ with x=1 to 5000,
diethylene glycol (C₂H₈O)(OH)₂,
propanediols (C₃H₆)(OH)₂,
neopentyl glycol (C₅H₁₀)(OH)₂,
cyclopentanediols (C₅H₈)(OH)₂,
cyclopentenediols (C₅H₆)(OH)₂,
glycerol (C₃H₅)(OH)₃,
pentanediols (C₅H₁₀)(OH)₂,
pentaerythritol (C₅H₈)(OH)₄,
hexanediols (C₆H₁₂)(OH)₂,
hexylene glycols (C₆H₁₂)(OH)₂,
heptanediols (C₇H₁₄)(OH)₂,
octanediols (C₈H₁₆)(OH)₂,
polycaprolactonediols, polycaprolactonetriols, hydroquinone (C₆H₄)(OH)₂,
resorcinol (C₆H₄)(OH)₂,
(pyro)catechol (C₆H₄)(OH)₂,
rucinol (C₁₀H₁₂)(OH)₂,
triethylene glycol (C₆H₁₂)(OH)₂,
fully aromatic, partly hydrogenated and/or fully hydrogenated bisphenol A (C₁₅H₁₄)(OH)₂, (C₁₅H₂₈)(OH)₂, bisphenol F (C₁₃H₁₀)(OH)₂, bisphenol S (C₁₂H₈O₂S)(OH)₂, and
tricyclodecanedimethanol (C₁₂H₁₈)(OH)₂, glycerol carbonate (C₄H₅)(OH)₁.

16. The potting compound as claimed in claim 1, wherein the hardener has a nitrogen density D in the range from 1 mmol/g to 15 mmol/g.

17. The potting compound as claimed in claim 1, wherein the hardener comprises compounds of the following structure types XI to XIV: 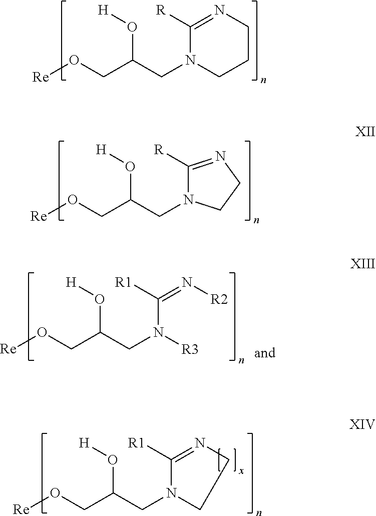
wherein
R1, R2 and R3 each comprise a substance selected from the group consisting of: methyl, ethyl, propyl, isopropyl, butyl, isobutyl, benzyl, and phenyl; and
x=1 to 12 and n=1 to 4.

18. The potting compound as claimed in claim 1, wherein the hardener comprises up to 25% by weight of the potting compound, based on the total mass of the potting compound.

19. The potting compound as claimed in claim 1, further comprising additives, flame retardants, and/or reactive diluents.

20-24. (canceled)
